(19) United States
(12) Patent Application Publication
(10) Pub. No.: US 2017/0066574 A1
(43) Pub. Date: Mar. 9, 2017

(54) CONTAINER WITH A SECURING DEVICE

(71) Applicant: KOCHER-PLASTIK MASCHINENBAU GMBH, Sulzbach-Laufen (DE)

(72) Inventors: Manfred SCHRECKENHOEFER, Sulzbach-Laufen (DE); Alexander HAMMER, Gaildorf (DE)

(73) Assignee: KOCHER-PLASTIK MASCHINENBAU GMBH, Sulzbach-Laufen (DE)

(21) Appl. No.: 15/123,319

(22) PCT Filed: Mar. 5, 2015
(86) PCT No.: PCT/EP2015/000497

§ 371 Date: Sep. 2, 2016

(30) Foreign Application Priority Data
Mar. 14, 2014 (DE) 10 2014 003 487.9

(51) Int. Cl. B65D 50/06; B65D 69/00; B65D 1/02; B65D 1/09; A61J 1/06

(52) U.S. Cl. CPC B65D 50/06; B65D 1/095; A61J 1/067; B65D 1/0238; B65D 69/00

(57) ABSTRACT

The invention relates to a container with a securing device (16), in particular in the form of a blow-molded plastic container, preferably in the form of an ampoule, comprising a storage part (4) for receiving a medium which can be dispensed via a container opening (10) and comprising a head part (6) which is removably connected to the storage part (4) via a separation point (12) and which releases the container opening (10) for a removal process of the medium after the head part has been separated from the storage part (4). The invention is characterized in that the separation of the head part (6) from the storage part (4) is completely prevented or at least hindered by means of the securing device (16) in a securing position, and the head part (6) can be removed from the storage part (4) without force via the separation point (12) in at least one release position.

The invention relates to a container with a safety device, in particular, in the form of a blow-molded plastic container, preferably in the form of an ampoule, comprising a storage part for receiving a medium which can be dispensed via a container opening and comprising a head part, which is releasably connected to the storage part via a separation point and which releases the container opening for a removal process of the medium after the head part has been separated from the storage part.

Containers with such safety devices are appropriate or even essential in situations where it is necessary to prevent easy dispensing of the medium from the container, more specifically, to prevent dispensing from taking place without having to undertake special measures to release the container opening. Complicating the removal of the contents of a container in question by using a safety device is necessary, in particular, as a child safety feature, when the container contains hazardous media and contact therewith or even oral consumption thereof would be fatal at least to a certain category of persons, for example, children. On the other hand, such a child safety feature, should not constitute so great an obstacle that older people, for example, can no longer access the container contents.

The present container solution is, in particular, produced according to a blow molding, filling and sealing process as it has now become known globally under the brand name bottelpack®. Container products produced according to the known bottelpack® method are produced in one piece from plastic, filled and then sealed preferably in sterile form. Such containers, which can also be in ampoule form, often contain dispensing media, mainly in the form of fluids for therapeutic purposes, which are intended for use by certain persons only which, in principle, necessitates a child safety feature.

A generic container with a safety device is known from WO 2007/112802 A1, wherein, in the case of the known solution, the container opening can be sealed by means of a first safety part, which opposes an opening force with a pre-definable resistance, wherein this pre-definable resistance may be overcome with the aid of a second safety part cooperating with the first safety part in order to release the container opening. In the case of the known solution, the pre-definable resistance can be selected such that, without the assistance of the second safety part, it is virtually impossible to overcome, or at least cannot be overcome by children. This makes a simple or unintentional opening more difficult and, in particular, ensures that children are not able to readily perform the operation sequence required to open the container opening without instructions.

A disadvantage of this known solution is that the safety device is designed as an auxiliary tool as the one safety part which, removed from the container, enables the actual opening process only by using this auxiliary tool to separate the head part as the other safety part from the storage part of the container via the separation point and, in this way, then releasing the container opening for a removal of media from the container. Aside from the possibility of the actuation tool becoming lost as a result of its removal from the container, it is also not possible to rule out improper user application of the tool in question, thus resulting in additional difficulties for the opening process.

Nor is it possible to rule out that older users in particular find the known child safety features too challenging and are thus also unable to initiate an opening process.

Based on this prior art, the object of the invention is thus to further improve the known solution such that a safety device, which is practically constructed with respect to the actuation, is provided and that it functions without an additional actuation tool. This object is achieved by a container with a safety device according to the configuration of features of claim 1 in its entirety.

Because, according to the characterizing portion of claim 1, the separation of the head part from the storage part is completely prevented or at least complicated by means of the safety device in a safety position and because, in at least one release position, the head part can be easily removed from the storage part via the separation point, a safe opening process for the storage part can be achieved without tools using the means of the container itself. In particular, all safety device parts required for this process can permanently remain on the container, so that no parts can become lost during unlocking either. The solution according to the invention is comprehensibly designed, so that older citizens in particular have no problems with opening the container and can easily manage the opening of the first container, which is equipped with such a safety device; only children in the age range in question, however, are unable to easily accomplish opening without instructions from adults. This safety concept has no equivalent in the prior art.

In a particularly preferred embodiment of the container solution according to the invention, the safety device has a securing bracket which, in the safety position, at least partially spans the head part in the manner of a bracket and which, in the respective release position, assumes a pivot position opposite the storage part, which pivot position releases the head part for an actuation, in particular for its manual removal from the storage part. Said securing bracket is easily haptically identifiable and can be moved with pre-definable actuation forces from its safety position to the release position.

It is particularly preferably provided that the securing bracket is pivotably linked to the storage part via its two ends facing the storage part by means of linkage points, so that the securing bracket does not, as the one safety part, become lost even after actuation and, together with the emptied container and with the separated head part as the other safety part, can be disposed of as a single unit. In particular, there is no need for complex opening processes using a separate actuation tool which is initially an integral component of the container solution (WO 2007/112802 A1).

Another preferred embodiment of the container according to the invention provides that the linkage points abut a frame of the storage part, which defines a midplane for the container and the wall thickness of which is selected thinner than the wall thickness for the securing bracket. Because the containers or ampoule products are, in the known bottelpack® production method, filled via mold halves that can be separated from one another with a plastic material of an extruded plastic hose, the safety device can easily be formed as a negative mold by a simplified cavity formation in said mold half pairs, which then in the blow molding process as a positive form produces the actuatable safety device for the respective container product. Because the securing bracket with its reinforced side wall forms the rest of the frame of the storage part for the container product, a very good contact surface for the manual unlocking of the safety device is thus provided and, in addition, the frame of the container storage part is reinforced in the safety position by means of the securing bracket wall such that protection is simultaneously provided against damage to the container, in particular, in the head part region from a possible third party influence.

It is furthermore preferably provided that the two linkage points are disposed diametral to a longitudinal axis of the container and are formed as trunnions. The respective linkage point is disposed in an area of the container, in which a cylindrical neck part of the storage part transitions into a conical taper, which ends at the container opening. Because of this design, a release of the safety device consists of easily being able to pivot the pivot bracket, in both possible opposite deflection directions, away from the container opening with the head part.

It is further particularly preferably provided that the free pivot path of the securing bracket can pivot from a zero position relative to the longitudinal axis of the container, which corresponds to the safety position, into an unlocked position, which corresponds to the release position, which varies from the zero position by at least 90° of pivot. This ensures, in any case, that the head part can be separated easily and unhindered from the container opening along the separation point after release of the safety device, with the securing bracket preferably being able to be pivoted back still further, preferably as far as a contact with the other wall parts of the container body, so that a simplified manipulation during removal with just one of the user's hands is ensured.

Because the securing bracket in its safety position is preferably releasably fixed by means of at least one connection part along the outer contour of the head part and/or of the neck part, it is possible in conjunction with the molding process to create a separation line for the container product between head part and securing bracket, which permits an unimpeded pivoting away or folding back of the securing bracket from the head part, and nevertheless reliably holds the securing bracket in the zero position, provided no external actuation force separates the respective connection point, which is designed as a predetermined breaking point, with a pre-determinable actuation force.

Containers in ampoule form of the aforementioned type are often marketed in the form of so-called “multiblocks” made up of several ampoules linked together. This design contributes further to child safety by requiring, as a further complication of the opening process, a prior manual separation of the container from the ampoule block, again using pre-determinable actuation force. Because, in the solution according to the invention, the securing bracket with its outer contour in the safety position forms a partial frame in the manner of a card part, which at least partially surrounds the storage part, and because the container is releasably connected via a separation point between neighboring card-type frames with at least one neighboring container, the securing bracket is, in the context of said multiblock formation, an integral component of the card design for the multiblock, which helps to simplify the production process.

According to the method according to the invention, in order to release the container opening, the securing bracket of the safety device must firstly be pivoted from its safety position or zero position so far away from the head part that the manipulation part of the head part or the head part itself can be twisted away from the container opening by a user via the separation point, wherein this may be achieved by a relative twisting movement between head part and storage part before the medium dispensing is initiated via the released container opening. The storage part with the pivoted back securing bracket can be held with one hand while twisting the head part with the other hand, this twisting movement can be initiated by an opposite rotation of head part and storage part, or the head part can be held and the storage part can be appropriately twisted, the foregoing being more easily implementable because the storage part as the larger container part can be securely clasped by the user's actuation hand.

The container with a safety device according to the invention is explained in greater detail below with reference to various exemplary embodiments according to the drawings.

In the drawings, depicted schematically and not to scale,

FIGS. 1 to 3 show in a front view, in a side view and in a top view, a multiblock made up of several container units according to the invention;

FIGS. 4 to 8 show in different actuation positions, the safety device for the container according to FIGS. 1 to 3, for the sake of simpler depiction, only the upper part of the container solution being depicted without the actual container body forming the storage part.

The invention is explained in greater detail below with reference to an exemplary embodiment according to FIGS. 1 to 7, in which the safety device in the form of a child safety feature complicates the opening process for plastic containers in ampoule form made from blow-molded plastic. Such ampoules can be produced in one piece, filled in a sterile manner and sealed using the bottelpack® method, for example. Such ampoules or containers can be marketed collectively as a so-called multiblock, particularly preferably as a unit consisting of several ampoules. In FIGS. 1 to 3, a multiblock with six ampoules joined at separation points 2 is in each case identified as a whole with the reference numeral 1. Each ampoule or container has, viewed in cross-section, a polygonal storage part 4 (FIG. 3) with an upper head part 6, which extends in the direction of a container opening 10, while forming a conical narrowing or tapering in the form of a neck part 8. As can be seen in particular from FIGS. 4 to 8, the head part 6 is releasably connected, by means of a separation point 12 of the predetermined breaking point type, to the neck part 8, which surrounds the container opening 10 at this point. The head part 6 can be separated or sheared off (twist-off-cap) from the front upper end of the head part 6 by means of a manipulation part 14. After separation of the head part 6, the container opening 10 is released accordingly and a dispensable medium can be removed from the storage part 4 via the container opening 10.

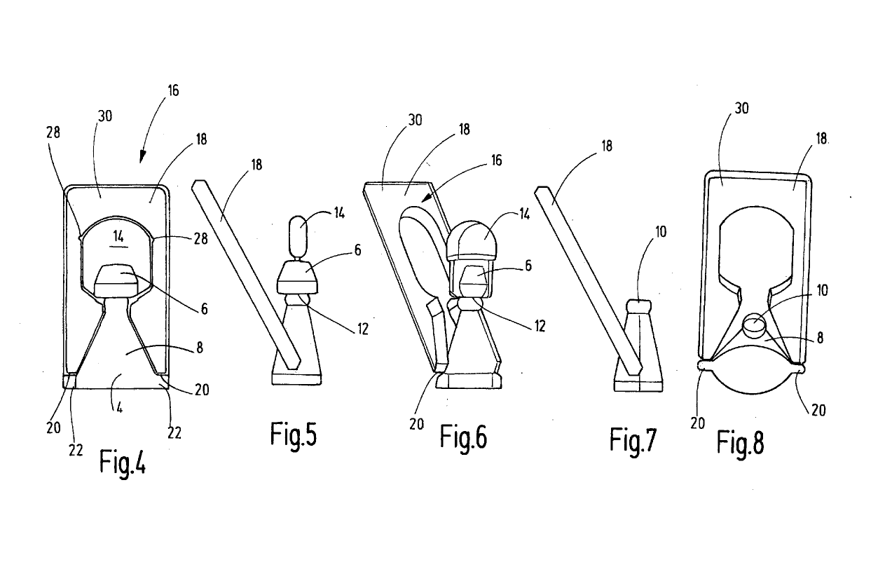

Furthermore, the container solution according to the invention is equipped with a safety device identified as a whole with the reference numeral 16 which, in a safety depiction according to the drawings of FIGS. 1 to 3 and 4, completely prevents or at least complicates the separation of the head part 6 from the storage part 4 with the neck part 8. Due to the assumed safety position, it is not possible to manually twist off the head part 6 via the separation point 12 and to remove it in the upwards direction as viewed in the viewing direction of the figures. In at least one release position however, as is depicted in FIGS. 5 to 8, the head part 6 can be easily removed from the storage part 4 via the separation point 12, with the head part 6 still being depicted in its sealed position according to FIGS. 5 and 6, and in FIGS. 7 and 8, the container opening 10 is released and the head part 6 is already removed.

The safety device 16 has a securing bracket 18 which, in the depicted safety position, at least partially spans the head part 6 in the manner of a bracket along its free outer circumference, with the securing bracket 18 assuming in its respective release position a pivot position opposite the storage part 4, which release position releases the head part 6 for an actuation, in particular, for its removal from the storage part 4. This folded back release position is reproduced in FIGS. 5 to 8.

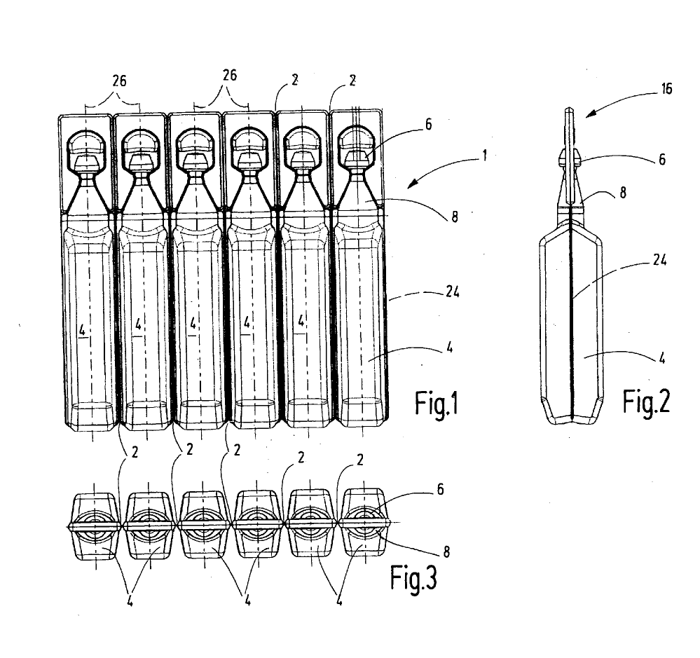

The securing bracket 18 is pivotably linked to the storage part at its two ends facing the storage part 4 by means of linkage points 20. Said linkage points 20 abut a frame 22 of the storage part 4, which defines a midplane 24 for the container and the wall thickness of which (cf. FIG. 2) is selected thinner than the wall thickness for the securing bracket 18.

As is seen in particular from FIG. 4, the two linkage points 20 are disposed diametral to a longitudinal or vertical axis 26 of the container and they are formed as trunnions (cf. FIG. 8). In addition, the respective linkage point 20 is disposed in an area of the container in which a cylindrical part of the neck part 8 transitions into a conical taper of the neck part, which ends at the container opening 10 (cf. FIGS. 5 and 6).

The free pivot path of the securing bracket 18, from the zero position, relative to the longitudinal or vertical axis 26 of the container, which corresponds to the safety position, into an unlocked position, which corresponds to the release position, can vary by at least 90°. The pivot position is preferably larger, however, and the securing bracket 18 can be pivoted back until it abuts at least with its upper end the upper side of container wall parts of the storage part 4. According to the depiction of FIGS. 5 to 8, the securing bracket 18 is, for the sake of simpler depiction, pivoted away from the longitudinal or vertical axis 26 of the container by approximately 30°.

As can also be seen from FIG. 4, the securing bracket 18 is, in its locked safety position depicted therein, releasably fixed along the outer contour of the head part 6 and of the conically tapered neck part 8 by means of two connection parts 28, which form a type of predetermined breaking point. The securing bracket 18 thus forms with its outer contour in the safety position a partial frame in the manner of a card part 30, which then at least partially also surrounds the storage part 4 in the area of the neck part 8. This solution requires punching the plastic material in this area, with the punching then excluding the connection parts 28, by means of which the securing bracket 18 can be separated from the head part 6 in a predetermined breaking point manner.

Another option is to provide a reduction of the wall thickness in the plastic material along the depicted separation line between head part 6 and the neck part 8 and the card part 30 of the securing bracket 18 which, when manually perforated, can then release the securing bracket 18. As the depiction according to FIG. 1 shows, these card parts 30 of neighboring containers abut one another and form, together with the aforementioned separation points 2, two continuous separation areas, to allow individual containers to be appropriately separated from the multiblock arrangement according to FIG. 1. Such separation points 2 within the multiblock arrangement 1 likewise delimit frames 22, from which the storage part 4 with a pre-determinable storage volume then projects.

A method for releasing the container opening 10, which is provided in a container with a safety device 16, then proceeds as follows. Firstly, the securing bracket 18 of the safety device 16, after tearing through the connection parts 28, is pivoted out of its safety position and so far away from the head part 6 and the neck part 8 that, by means of the manipulation part 14, the head part 6 is twisted away from the separation point 12 by a user. The container opening 10 is thus then released (cf. FIG. 8) and, to ensure an interference-free removal process, the securing bracket 18 of the safety device 16 is manually pivoted back to an appropriate extent.

1. A container with a safety device (16), in particular, in the form of a blow-molded plastic container, preferably in the form of an ampoule, comprising a storage part (4) for receiving a medium which can be dispensed via a container opening (10) and comprising a head part (6), which is releasably connected to the storage part (4) via a separation point (12), and which releases the container opening (10) for a removal process of the medium after the head part has been separated from the storage part (4), characterized in that the separation of the head part (6) from the storage part (4) is completely prevented or at least complicated by means of the safety device (16) in a safety position, and in that, in at least one release position, the head part (6) can be easily removed from the storage part (4) via the separation point (12).

2. The container according to claim 1, characterized in that the safety device (16) has a securing bracket (18) which, in the safety position, at least partially spans the head part (6) in the manner of a bracket and which, in the respective release position, assumes a pivot position opposite the storage part (4), which pivot position releases the head part (6) for an actuation, in particular for its removal from the storage part (4).

3. The container according to claim 1, characterized in that the securing bracket (18) is pivotably linked to the storage part (4) via its two ends facing the storage part (4) by means of linkage points (20).

4. The container according to claim 1, characterized in that the linkage points (20) abut a frame (22) of the storage part (4) which defines a midplane (24) for the container and the wall thickness of which is selected thinner than the wall thickness for the securing bracket (18).

5. The container according to claim 1, characterized in that the two linkage points (20) are disposed diametral to a longitudinal axis (26) of the container and are formed as trunnions.

6. The container according to claim 1, characterized in that the respective linkage point (20) is disposed in an area of the container in which a cylindrical neck part (8) of the storage part transitions into a conical taper of this neck part (8), which ends at the container opening (10).

7. The container according to claim 1, characterized in that the free pivot path of the securing bracket (18) can pivot from a zero position relative to the longitudinal axis (26) of the container, which corresponds to the safety position, into an unlocked position, which corresponds to the release position, which varies from the zero position by at least 90° of pivot.

8. The container according to claim 1, characterized in that the securing bracket (18) in its safety position is releasably fixed by means of at least one connection part (28) along the outer contour of the head part (6) and/or of the neck part (8).

9. The container according to claim 1, characterized in that the securing bracket (18) with its outer contour in the safety position forms a partial frame in the manner of a card part (30), which at least partially surrounds the storage part (4).

10. The container according to claim 1, characterized in that it is releasably connected via a separation point (2) between neighboring card-type frames (22) with at least one neighboring container.

11. A method for releasing the container opening, which is provided in a container with a safety device according to claim 1, characterized in that the securing bracket (18) of the safety device (16) is pivoted out of its safety position and so far away from the head part (6) that the manipulation (14) of the head part (6) by a user is made possible, who, by means of a relative twisting movement between head part (6) and storage part (4) removes the head part (6) via the separation point (12) and thus releases the container opening (10) for a media dispensing.
